(19) United States
(12) Patent Application Publication
(10) Pub. No.: US 2006/0059910 A1
(43) Pub. Date: Mar. 23, 2006

(54) Pressure-charged internal combustion engine

(76) Inventors: Uwe R. Spaeder, Aachen (DE); Norbert A. Schorn, Aachen (DE); Helmut M. Kindl, Aachen (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 11/232,607

(22) Filed: Sep. 22, 2005

(30) Foreign Application Priority Data
Sep. 22, 2004 (EP) 04104600.4

(51) Int. Cl. F01N 5/04; F02B 33/44

(52) U.S. Cl. 60/612; 60/280

(57) ABSTRACT

The invention relates to a system and method for improving the emission characteristics of a pressure-charged internal combustion engine. The engine (1) has an intake line (2) and an exhaust-gas line (4) and at least two exhaust-gas turbochargers (6, 7) connected in series. Each turbocharger has a turbine (6a, 7a) in the exhaust-gas line (4) and a compressor (6b, 7b) in the intake line (2). The first exhaust-gas turbocharger (6) serves as high-pressure stage (6). The second exhaust-gas turbocharger (7) serves as low-pressure stage (7). Two exhaust-gas aftertreatment systems are located in between and after the turbines.

### FIELD OF THE INVENTION

The invention relates to a system and method for improving the emission characteristics of a pressure-charged internal combustion engine.

### BACKGROUND AND SUMMARY OF THE INVENTION

In recent years, there has been a development toward small, highly pressure-charged engines, the pressure-charging primarily being a method of increasing the power in which the air required for the engine combustion process is compressed. The economic importance of these engines for the automotive industry is steadily increasing.

As a rule, an exhaust-gas turbocharger, in which a compressor and a turbine are arranged on the same shaft, is used for the pressure-charging, the hot exhaust-gas flow being fed to the turbine and expanding in this turbine while delivering energy, as a result of which the shaft is set in rotation. The energy delivered by the exhaust-gas flow to the turbine and finally to the shaft is used for driving the compressor, likewise arranged on the shaft. The compressor delivers and compresses the charge air fed to it, as a result of which pressure-charging of the cylinders is achieved.

The advantages of the exhaust-gas turbocharger, for example in comparison with mechanical chargers, consist in the fact that there is no mechanical connection for the power transfer between charger and internal combustion engine, or such a mechanical connection is not required. Whereas a mechanical charger draws the energy required for its drive entirely from the mechanical energy provided at the crankshaft by the internal combustion engine and thus reduces the power provided and in this way adversely affects the efficiency, the exhaust-gas turbocharger uses the energy of the hot exhaust gases produced by the internal combustion engine. Here, too, a reduction in the efficiency may occur, since the exhaust-gas counterpressure is increased compared with the naturally aspirated engine.

A typical example of the small, highly pressure-charged engines is an internal combustion engine with exhaust-gas turbocharging in which the exhaust-gas energy is used for compressing the combustion air and which additionally has charge-air cooling, with which the compressed combustion air is cooled before entering the combustion chamber and thus the density of the combustion air is increased.

The pressure-charging primarily serves to increase the power of the internal combustion engine. The air required for the combustion process is compressed, as a result of which a larger air mass can be fed to each cylinder per operating cycle. The fuel mass and thus the mean pressure pₘₑ can be increased as a result.

Pressure-charging is therefore a suitable means for increasing the power of an internal combustion engine at an unchanged swept volume, or for reducing the swept volume at the same power. In each case, the pressure-charging leads to an increase in the power density and in a more favorable power-to-weight ratio. Under the same vehicle boundary conditions, the load spectrum can thus be displaced toward higher loads.

Pressure-charging consequently assists the constant effort made in the development of internal combustion engines to minimize the fuel consumption, i.e., to improve the efficiency of the internal combustion engine, on account of the limited resources of fossil energy carriers, in particular on account of the limited deposits of mineral oil as raw material for the preparation of fuels for the operation of internal combustion engines.

A further basic aim is to reduce the pollutant emissions. The pressure-charging of the internal combustion engine can likewise help to achieve this object. This is because, if the pressure-charging is designed in a specific manner, advantages with regard to the efficiency and the exhaust-gas emissions can be achieved. Thus, by suitable pressure-charging, for example in the diesel engine, the nitrogen oxide emissions can be reduced without losses in efficiency. At the same time, the hydrocarbon emissions can be favorably affected. The emissions of carbon dioxide, which correlate directly with the fuel consumption, likewise decrease with decreasing fuel consumption.

The torque characteristic of a pressure-charged internal combustion engine can be improved, for example, by pressure-charging. In this case, a plurality of turbochargers connected in parallel and having correspondingly small turbine cross sections are activated with increasing load.

Finally, the torque characteristic can also be advantageously influenced by a plurality of exhaust-gas turbochargers connected in series, as is the case in the internal combustion engine which is the subject matter of the present invention. By a plurality of exhaust-gas turbochargers being connected in series, the enveloping virtual compressor characteristic map of the individual characteristic maps can be widened, to be precise toward both smaller compressor flows and larger compressor flows. In particular, a displacement of the pumping limit toward smaller mass flows is possible, as a result of which high charge-pressure ratios can be achieved even at small engine speeds and thus during small mass flows, and the torque characteristic within this range can be markedly improved.

Two exhaust-gas turbochargers connected in series offer even further advantages. The increase in power by pressure-charging can be further increased; the downsizing is extended further by multistage pressure-charging by exhaust-gas turbochargers. Furthermore, the response behavior of such a pressure-charged internal combustion engine is markedly improved compared with a comparable internal combustion engine with single-stage pressure-charging. The reason for this can be found in the fact that the smaller exhaust-gas turbocharger used for the lower speed range is less sluggish than a large exhaust-gas turbocharger, or the moving elements can be accelerated and decelerated more quickly.

An engine system and method are disclosed which overcomes disadvantages in the prior art. The engine has an intake line for supplying fresh air and an exhaust-gas line for discharging the exhaust gas and at least two exhaust-gas turbochargers which are connected in series and which each comprise a turbine arranged in the exhaust-gas line and a compressor arranged in the intake line and of which a first exhaust-gas turbocharger serves as high-pressure stage and a second exhaust-gas turbocharger arranged downstream of the exhaust-gas line and upstream of the intake line of the first exhaust-gas turbocharger serves as low-pressure stage, a first exhaust-gas aftertreatment system being provided downstream of the turbine of the second exhaust-gas turbocharger, and a second exhaust-gas treatment system of the same type being additionally provided. The rotor diameter of the low-pressure turbine is designed to be larger than the rotor diameter of the high-pressure turbine.

By suitable changeover devices and bypass lines, the exhaust-gas flow can be deflected in such a way that it can be directed past both turbines. This offers advantages with regard to a catalytic converter arranged in the exhaust-gas line downstream of the turbines, in particular after a cold start or during the warm-up period of the internal combustion engine, since the hot exhaust gases are fed directly to the catalytic converter and are not only directed through the turbines, which are to be regarded as a heat sink, while giving off heat. In this way, the catalytic converter reaches its light-off temperature more quickly after a cold start or during the warm-up period, this light-off temperature being around 300° C. and being characterized by the fact that a perceptible increase in the conversion of the pollutants can be observed.

European Patent Application EP 1 396 619 A1 thus addresses a conflict which occurs during the simultaneous use of exhaust-gas turbochargers and exhaust-gas aftertreatment systems and can only be resolved inadequately according to the prior art.

On the one hand, it is attempted to arrange the exhaust-gas turbochargers as close to the exhaust of the internal combustion engine as possible in order to optimally utilize the exhaust-gas enthalpy of the hot exhaust gases in this way. On the other hand, however, the hot exhaust gases are to cover as short a distance as possible to the various exhaust-gas aftertreatment systems so that these exhaust gases have little time to cool down and the exhaust-gas aftertreatment systems reach their operating temperature or light-off temperature as quickly as possible. In this connection, therefore, attempts are made in principle to minimize the thermal inertia of the section of the exhaust-gas line between exhaust and exhaust-gas aftertreatment system, which can be achieved by reducing the mass and the length of this section.

To improve the emission behavior, European Patent Application EP 1 396 619 A1 proposes that a second catalytic converter, i.e., a second exhaust-gas aftertreatment system, which is of the same type as the first exhaust-gas aftertreatment system, be arranged in a bypass line bypassing the turbine in order to shorten the length of the exhaust-gas line section between the exhaust of the internal combustion engine and the catalytic converter. The thermal inertia of this section is additionally reduced by eliminating the turbines.

A disadvantage with the concept proposed in EP 1 396 619 A1 is that either the exhaust-gas flow, with regard to a good emission behavior, is fed directly to an exhaust-gas aftertreatment means, in the course of which the internal combustion engine is not pressure-charged as a result of the exhaust-gas turbochargers being bypassed, or else prominence is given to the pressure-charging of the internal combustion engine, the emission behavior being disregarded.

Furthermore, the entire exhaust-gas line system, on account of the numerous bypass lines and additional exhaust-gas lines, is very complex and voluminous and therefore also costly. Such an exhaust-gas system conflicts with the basic aim of the designer to realize as effective a packaging of the entire drive unit as possible, i.e., as compact a packaging of the drive unit as possible, in the engine compartment of the motor vehicle.

At this point, it is to be pointed out that the present invention, in contrast to European Patent Application EP 1 396 619 A1, is not restricted to catalytic converters but deals with exhaust-gas aftertreatment systems in general.

The problems described using the catalytic converter as an example also occur in a similar manner in other exhaust-gas aftertreatment systems. Both the oxidation catalytic converters used for diesel engines and the three-way catalytic converters used in spark-ignition engines require a certain operating temperature in order to convert the pollutants to a sufficient extent and perceptibly reduce the pollutant emissions.

To minimize the emission of soot particles, “regenerative particle filters” are used according to the prior art, these particle filters filtering the soot particles out of the exhaust gas and storing them, these soot particles being burned intermittently in the course of the regeneration of the filter. In the process, the regeneration intervals are determined by the exhaust-gas backpressure, which occurs as a result of the increasing flow resistance of the filter on account of the increasing particle mass in the filter.

The high temperatures for the regeneration of the particle filter—around 550° C. when there is no catalytic assistance—are achieved during operation only at high loads and high speeds. Additional measures therefore have to be taken in order to ensure regeneration of the filter under all operating conditions.

In this case, the combustion of the particles can be assisted or initiated by a post injection of additional fuel into the combustion chamber. Here, the post-injected fuel can already be ignited in the combustion chamber, which may take place due to the terminating main combustion or due to the high temperatures present toward the end of the combustion in the combustion chamber, so that the exhaust-gas temperature of the exhaust gases expelled into the exhaust-gas duct is increased inside the engine. Disadvantages with this procedure are in particular the heat losses to be feared in the exhaust-gas duct on the way to the filter and the associated temperature reduction in the hot exhaust gases. With the use of a particle filter, this likewise requires the filter to be arranged as close as possible to the exhaust of the internal combustion engine.

An advantage of the present invention is that it provides better emission characteristics during the warm-up period.

The first partial object is achieved by a pressure-charged internal combustion engine having an intake line for supplying fresh air and an exhaust-gas line for discharging the exhaust gas and at least two exhaust-gas turbochargers which are connected in series and which each comprise a turbine arranged in the exhaust-gas line and a compressor arranged in the intake line and of which a first exhaust-gas turbocharger serves as high-pressure stage and a second exhaust-gas turbocharger arranged downstream of the exhaust-gas line and upstream of the intake line of the first exhaust-gas turbocharger serves as low-pressure stage, an exhaust-gas aftertreatment system being provided downstream of the turbine of the second exhaust-gas turbocharger, and a second exhaust-gas treatment system of the same type being additionally provided, wherein the second exhaust-gas aftertreatment system is arranged in the exhaust-gas line between the two turbines of the at least two exhaust-gas turbochargers.

The internal combustion engine according to the invention is equipped with a second exhaust-gas aftertreatment system which is of the same type as the first exhaust-gas aftertreatment system, this second exhaust-gas aftertreatment system is arranged between the two turbines of the at least two exhaust-gas turbochargers.

The internal combustion engine according to the invention thus ensures an improved emission behavior during the warm-up period or after a cold start due to the arrangement of the exhaust-gas aftertreatment system close to the exhaust of the internal combustion engine, and furthermore this internal combustion engine permits simultaneous pressure-charging.

An additional advantage of the present invention is that additional exhaust-gas lines are not required as a result of the arrangement of the second exhaust-gas aftertreatment system between the turbines.

On account of this arrangement according to the invention of the second exhaust-gas aftertreatment system, the entire exhaust-gas pipe system is very similar to the exhaust-gas pipe system of a conventional internal combustion engine in which two exhaust-gas turbochargers are connected in series and an exhaust-gas aftertreatment system is provided downstream of the low-pressure turbine and is not more complex or more voluminous than this conventional pipe system. There are therefore likewise no disadvantages with regard to the packaging.

Embodiments of the internal combustion engine are advantageous in which a first bypass line is provided which branches off from the exhaust-gas line upstream of the turbine of the first exhaust-gas turbocharger and opens into the exhaust-gas line again downstream of the second exhaust-gas aftertreatment system, a valve being arranged in this first bypass line. In this case, the valve is preferably adjustable in an infinitely variable manner.

The bypass line allows the high-pressure turbine together with the exhaust-gas aftertreatment system arranged downstream of this turbine to be bypassed. This enables, for example, the high-pressure turbine to be designed specifically for small mass flows or for low speeds, that is to say for that operating range of the internal combustion engine which is relevant to the warm-up period and the tests for determining the exhaust-gas emissions, so that, under these operating conditions, the internal combustion engine has an improved emission behavior and is also pressure-charged. The pumping limit is in this case displaced toward smaller compressor mass flows, so that high charge pressures can be achieved even during small and minimum mass flows.

The valve allows the total exhaust-gas flow to be divided into two exhaust-gas partial flows, namely into an exhaust-gas partial flow which is passed through the bypass line and an exhaust-gas partial flow which is directed through the high-pressure turbine and the exhaust-gas aftertreatment system. This permits many different procedures. With increasing total exhaust-gas flow, an increasing proportion of the total exhaust-gas flow can be passed through the bypass line and fed directly to the low-pressure turbine—a scenario which presents itself in particular as soon as the exhaust-gas aftertreatment system arranged downstream of the low-pressure turbine has reached its operating temperature.

Embodiments of the internal combustion engine in which the valve is a valve are advantageous, this valve being electrically, hydraulically, pneumatically or magnetically controllable.

Embodiments of the internal combustion engine in which the valve is a butterfly valve are advantageous. A butterfly valve is certainly not suitable for completely closing the bypass line, so that a leakage flow is not entirely avoided even when the butterfly valve is closed. However, this proves to be harmless in practice.

Embodiments of the internal combustion engine in which the second exhaust-gas aftertreatment system is volumetrically smaller than the first exhaust-gas aftertreatment system are advantageous. This embodiment takes into account the fact that the internal combustion engine, after a cold start or during the warm-up period, is operated within the medium and lower part-load range or at low speeds, i.e., during small mass flows, and the exhaust-gas mass flow passed through the exhaust-gas aftertreatment systems in these operating states has a corresponding order of magnitude. Since the second exhaust-gas aftertreatment system is primarily provided for the purpose of improving the emission behavior of the internal combustion engine in precisely these operating states, the second exhaust-gas aftertreatment system can be dimensioned in accordance with the exhaust-gas mass flow present and to be treated in these operating states.

It may be noted at this point that the high-pressure turbine is preferably designed for small mass flows.

In a diesel engine, the mass flow delivered by the engine is determined to a considerable extent by the speed, so that small mass flows and low speeds correlate with one another. For spark-ignition engines, the mass flows are small at low loads, since spark-ignition engines, in contrast to diesel engines, do not have control of the quality but rather have control of the quantity.

Embodiments of the internal combustion engine in which the exhaust-gas aftertreatment system is an oxidation catalytic converter are advantageous. An oxidation catalytic converter which is used for exhaust-gas aftertreatment in diesel engines has satisfactory rates of conversion only upon reaching a certain temperature, for which reason, with regard to an improved emission behavior, it serves the purpose to arrange this catalytic converter as close to the exhaust of the internal combustion engine as possible in order to shorten the warm-up period of the catalytic converter.

Embodiments of the internal combustion engine in which the exhaust-gas aftertreatment system is a soot filter are advantageous. As has already been explained in the introduction, it is necessary to regenerate the filter from time to time, the soot particles deposited in the filter being burned intermittently in the course of the regeneration of the filter. As a rule, the combustion of the particles is initiated by a specific increase in the exhaust-gas temperature, which may be effected by a post injection of fuel into the cylinders. With regard to the regeneration of the filter, therefore, an arrangement close to the engine serves the purpose. Consequently, the configuration according to the invention of the internal combustion engine also offers advantages when using soot filters as exhaust-gas aftertreatment system.

Embodiments of the internal combustion engine in which the exhaust-gas aftertreatment system is a three-way catalytic converter are advantageous. What has been said with regard to oxidation catalytic converter likewise applies to the three-way catalytic converter, for which reason reference is made to these embodiments.

Embodiments of the internal combustion engine are advantageous in which a second bypass line is provided which branches off from the intake line upstream of the compressor of the first exhaust-gas turbocharger and opens into the intake line again downstream of the compressor of the first exhaust-gas turbocharger, a valve being arranged in this second bypass line.

This second bypass line allows the high-pressure compressor to be bypassed. This enables the fresh-air mass flow passed through the high-pressure compressor to be matched to the exhaust-gas mass flow passed through the high-pressure turbine and thus to the turbine output available.

The valve allows the total fresh-air flow to be divided into two partial flows, namely into a partial flow which is passed through the second bypass line and a partial flow which is directed through the high-pressure compressor.

Embodiments of the internal combustion engine in which a charge-air cooler is arranged in the intake line downstream of the compressors are advantageous. The charge-air cooler reduces the air temperature and thus increases the density of the air, as a result of which the cooler also helps to fill the combustion chamber with air more effectively, i.e., contributes to a larger air mass.

Embodiments of the internal combustion engine in which the turbine of the first exhaust-gas turbocharger has a variable turbine geometry (VTG) are advantageous. A variable turbine geometry increases the flexibility of the pressure-charging. It allows an infinitely variable adaptation of the turbine geometry to the respective operating point of the internal combustion engine. In contrast to a turbine having a fixed geometry, no compromise has to be made in the design of the turbine to realize more or less satisfactory pressure-charging within all the speed ranges.

Embodiments of the internal combustion engine in which the compressor of the first exhaust-gas turbocharger has a variable compressor geometry (VCG) are advantageous. This embodiment is especially advantageous when the turbine of the first exhaust-gas turbocharger has a variable turbine geometry and the compressor geometry is continuously matched to the turbine geometry.

Embodiments of the internal combustion engine in which the turbine of the second exhaust-gas turbocharger has a variable turbine geometry (VTG) are advantageous. What has been said above likewise applies to the turbine of the low-pressure stage, for which reason reference is made to these embodiments.

Embodiments of the internal combustion engine in which a third bypass line is provided for the purposes of exhaust-gas bleeding are advantageous, this third bypass line branching off from the exhaust-gas line upstream of the turbine of the second exhaust-gas turbocharger and opening into the exhaust-gas line again upstream of the first exhaust-gas aftertreatment system, it being possible for the turbine of the second exhaust-gas turbocharger to be bypassed by this third bypass line, a valve being provided in the third bypass line for controlling the exhaust-gas bleeding.

A method for operating a pressure-charged internal combustion engine of the type described is disclosed in which the predominant proportion of the exhaust-gas flow is directed through the turbine of the first exhaust-gas turbocharger and the second exhaust-gas aftertreatment system provided downstream of the turbine.

Spark-ignition and diesel engines have a different behavior here in regard to mass flow. Low mass flows in spark-ignition engines occur at low torques and mass flows in diesel engines depend on the speed. Low exhaust-gas mass flows are to be observed at low speeds.

What has been said in connection with the internal combustion engine according to the invention likewise applies to the method according to the invention. The arrangement of a second exhaust-gas aftertreatment system between the turbines makes it possible to optimize the emission behavior, in particular during the warm-up period, without at the same time having to dispense with pressure-charging. In addition, the high-pressure turbine can be designed specifically for the lower torque range or speed range relevant to the warm-up period, i.e., for small exhaust-gas mass flows, to realize charge pressures even during small exhaust-gas mass flows. This can be achieved or assisted, for example, by a small turbine having a fixed turbine geometry or else by a turbine having a variable turbine geometry.

Embodiments of the method are advantageous in which, during the warm-up period of the internal combustion engine, during small exhaust-gas mass flows, i.e., within the lower range in torque or speed, the exhaust-gas flow is directed completely through the turbine of the first exhaust-gas turbocharger and the second exhaust-gas aftertreatment system provided downstream of the turbine. To this end, the valve provided in the first bypass line is completely closed. In this way, the enthalpy of the entire exhaust-gas flow can be used for compressing the fresh air. The valve provided in the second bypass line is likewise preferably completely closed in the process. Furthermore, the entire exhaust-gas flow is in this case fed to the second exhaust-gas aftertreatment system arranged close the exhaust of the internal combustion engine and is used for heating this system, so that this system reaches its operating temperature as quickly as possible.

Embodiments of the method are advantageous in which, with increasing operating temperature and/or increasing speed and/or increasing torque, an increasing proportion of the exhaust-gas flow is directed via the first bypass line. This offers advantages in particular in high-pressure turbines having a fixed turbine geometry, in which—in contrast to turbines having a variable turbine geometry—the increasing exhaust-gas mass flow can be taken into account only by exhaust-gas bleeding.

Embodiments of the method in which more than 80% of the exhaust-gas flow is directed via the first bypass line after the light-off temperature of the first exhaust-gas aftertreatment system has been reached are advantageous. The substantial proportion of the exhaust-gas flow is directed past the high-pressure turbine and is passed directly to the low-pressure turbine. This offers advantages in particular if the high-pressure turbine is designed for small mass flows or low torque and the second exhaust-gas aftertreatment system is no longer absolutely necessary for the reduction of the pollutant emissions. The low-pressure turbine is in this case designed for high torque or large exhaust-gas mass flows, so that, in a certain manner, a division of tasks between high-pressure turbine and low-pressure turbine occurs in such a way that the predominant proportion of the exhaust-gas mass flow is directed through the low-pressure turbine during small exhaust-gas mass flows and through the high-pressure turbine during large exhaust-gas mass flows.

Embodiments of the method are advantageous in which, during operation of the internal combustion engine, some of the exhaust-gas flow is always directed through the turbine of the first exhaust-gas turbocharger and the second exhaust-gas aftertreatment system provided downstream of the turbine.

The exhaust-gas flow through the high-pressure turbine should never be completely prevented, so that the rotor or rotors of the turbine constantly rotate at a certain minimum speed. This is advantageous, since the rotors according to the prior art are equipped with plain bearings, and a certain speed is required so that the hydrodynamic lubricating-oil film of the plain bearing is built up and maintained. In this way, liquid friction in the plain bearing is ensured under all operating conditions, a factor which is favorable with regard to the wear and the service life or the operability of the turbine.

In internal combustion engines which have a second bypass line which branches off from the intake line upstream of the compressor of the first exhaust-gas turbocharger and opens into the intake line again downstream of the compressor of the first exhaust-gas turbocharger and in which a valve is arranged in this second bypass line, embodiments of the method in which the valve arranged in the second bypass line is controlled as a function of the adjusted position of the valve arranged in the first bypass line are advantageous, so that the compressor mass flow passed through the compressor of the first exhaust-gas turbocharger is adapted to the exhaust-gas mass flow passed through the turbine of this exhaust-gas turbocharger, or these two flows are matched to one another.

Furthermore, in internal combustion engines which have a third bypass line for the purposes of exhaust-gas bleeding, this third bypass line branching off from the exhaust-gas line upstream of the turbine of the second exhaust-gas turbocharger and opening into the exhaust-gas line again upstream of the first exhaust-gas aftertreatment system, it being possible for the turbine of the second exhaust-gas turbocharger to be bypassed by this third bypass line, and a valve being provided in the third bypass line for controlling the exhaust-gas bleeding, embodiments of the method are advantageous in which, with increasing load, an increasing proportion of the exhaust-gas mass flow is bled off by the third bypass line. In this variant, the low-pressure turbine is designed as a wastegate turbine.

### BRIEF DESCRIPTION OF DRAWINGS

The invention is described in more detail below with reference to FIGS. 1 to 7.

FIG. 1 schematically shows a first embodiment of the internal combustion engine;

FIG. 2 schematically shows a second embodiment of the internal combustion engine;

FIG. 3 schematically shows a third embodiment of the internal combustion engine;

FIG. 4 schematically shows a fourth embodiment of the internal combustion engine;

FIG. 5 schematically shows a fifth embodiment of the internal combustion engine;

FIG. 6 schematically shows a sixth embodiment of the internal combustion engine; and

FIG. 7 schematically shows a seventh embodiment of the internal combustion engine.

### DETAILED DESCRIPTION

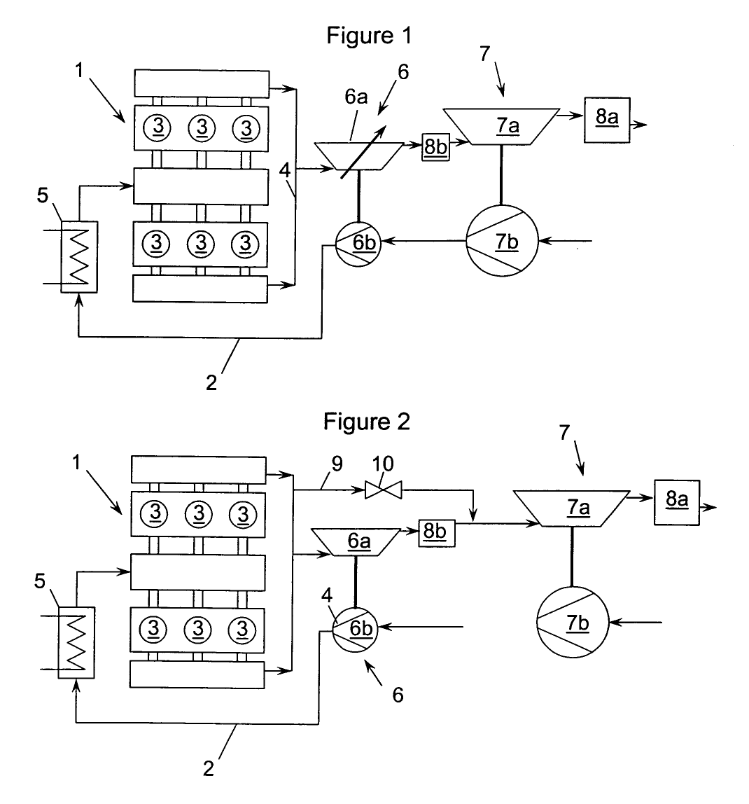

FIG. 1 shows a first embodiment of a pressure-charged internal combustion engine 1, taking a six-cylinder V engine as an example.

The internal combustion engine 1 has an intake line 2 which supplies the cylinders 3 with fresh air and also an exhaust-gas line 4 which serves to discharge the combustion gases or the exhaust gas. Furthermore, the internal combustion engine 1 is equipped with two exhaust-gas turbochargers 6, 7 which are connected in series, so that, on the one hand, the exhaust-gas flow flows through two turbines 6a, 7a arranged one behind the other in the exhaust-gas line 4, whereas the charge-air flow is passed through to compressors 6b, 7b arranged one behind the other in the intake line 2. A first exhaust-gas turbocharger 6 arranged close to the exhaust of the internal combustion engine 1 serves as high-pressure stage 6. A second exhaust-gas turbocharger 7 arranged downstream of the exhaust-gas line 4 or upstream of the intake line 2 of the first exhaust-gas turbocharger 6 serves as low-pressure stage 7.

A first exhaust-gas aftertreatment system 8a is provided downstream of the turbine 7a of the second exhaust-gas turbocharger 7. A second exhaust-gas aftertreatment system 8b of the same type as the first exhaust-gas aftertreatment system 8a is additionally provided, this second exhaust-gas aftertreatment system 8b being arranged in the exhaust-gas line 4 between the two turbines 6a, 7a of the two turbochargers 6, 7 and thus being positioned substantially closer to the exhaust of the internal combustion engine 1 than the first exhaust-gas aftertreatment system 8a.

Downstream of the compressors 6b, 7b, a charge-air cooler 5 is arranged in the intake line 2. The charge-air cooler 5 reduces the air temperature and thus increases the density of the air, as a result of which the cooler 5 also helps to fill the cylinders 3 with air more effectively, i.e., contributes to a larger air mass.

In the exemplary embodiment shown in FIG. 1, the turbine 6a of the first exhaust-gas turbocharger 6 has a variable turbine geometry (VTG—identified by the arrow), which enables the turbine geometry to be adapted to the respective operating point of the internal combustion engine 1 in an infinitely variable manner. In contrast to a turbine having a fixed geometry, no compromise has to be made in the design of the turbine to realize satisfactory pressure-charging within all the speed ranges. The compressor 6b of the high-pressure stage 6 may have a fixed geometry or may alternatively be designed with a variable compressor geometry.

The low-pressure turbine 7a has a fixed turbine geometry, but may in principle also be designed with a variable turbine geometry. The same applies to the low-pressure compressor 7b.

FIG. 2 schematically shows a second embodiment of the pressure-charged internal combustion engine 1. Only the differences from the embodiment shown in FIG. 1 are to be discussed, for which reason reference is otherwise made to FIG. 1. The same designations have been used for the same components.

In contrast to the embodiment shown in FIG. 1, the high-pressure turbine 6a in the internal combustion engine 1 shown in FIG. 2 is designed with a fixed, i.e., invariable, turbine geometry. In addition, a first bypass line 9 is provided, which branches off from the exhaust-gas line 4 upstream of the turbine 6a of the first exhaust-gas turbocharger 6 and opens into the exhaust-gas line 4 again downstream of the second exhaust-gas aftertreatment system 8b, a valve 10 being arranged in this first bypass line 9.

The bypass line 9 serves as an exhaust-gas bleed line. The high-pressure turbine 6a is thus designed in a similar manner to a wastegate turbine, it being possible for the second exhaust-gas aftertreatment system 8b to be additionally bypassed by the bypass line 9. The valve 10 allows the total exhaust-gas flow to be divided into two exhaust-gas partial flows, namely into an exhaust-gas partial flow which is passed through the bypass line 9 and an exhaust-gas partial flow which is directed through the high-pressure turbine 6a and the second exhaust-gas aftertreatment system 8b.

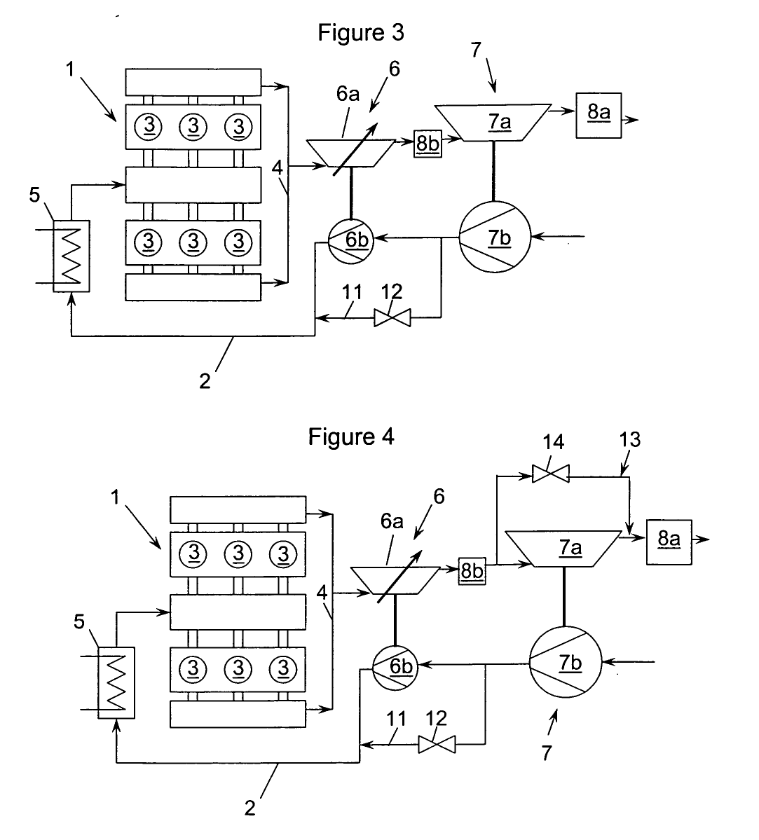

FIG. 3 schematically shows a third exemplary embodiment of the pressure-charged internal combustion engine 1. Only the differences from the embodiment shown in FIG. 1 are to be discussed, for which reason reference is otherwise made to FIG. 1. The same designations have been used for the same components.

In contrast to the embodiment shown in FIG. 1, a second bypass line 11 is provided in the internal combustion engine 1 shown in FIG. 3, this second bypass line 11 branching off from the intake line 2 upstream of the compressor 6b of the first exhaust-gas turbocharger 6 and opening into the intake line 2 again downstream of the compressor 6b of the first exhaust-gas turbocharger 6, a valve 12 being arranged in this second bypass line 11.

The second bypass line 11 allows the high-pressure compressor 6b to be bypassed. This enables the fresh-air mass flow passed through the high-pressure compressor 6b to be matched to the exhaust-gas mass flow passed through the high-pressure turbine 6a and thus permits adaptation to the turbine output instantaneously available.

FIG. 4 schematically shows a fourth embodiment of the pressure-charged internal combustion engine 1. In contrast to the embodiment shown in FIG. 3, a third bypass line 13 is provided for the purposes of exhaust-gas bleeding, this third bypass line 13 branching off from the exhaust-gas line 4 upstream of the turbine 7a of the second exhaust-gas turbocharger 7 and opening into the exhaust-gas line 4 again upstream of the first exhaust-gas aftertreatment system 8a, it being possible for the turbine 7a of the second exhaust-gas turbocharger 7 to be bypassed by this second bypass line 13, a valve 14 being provided in the third bypass line 13 for controlling the exhaust-gas bleeding. The low-pressure turbine 7a is thus designed in the form of a wastegate turbine.

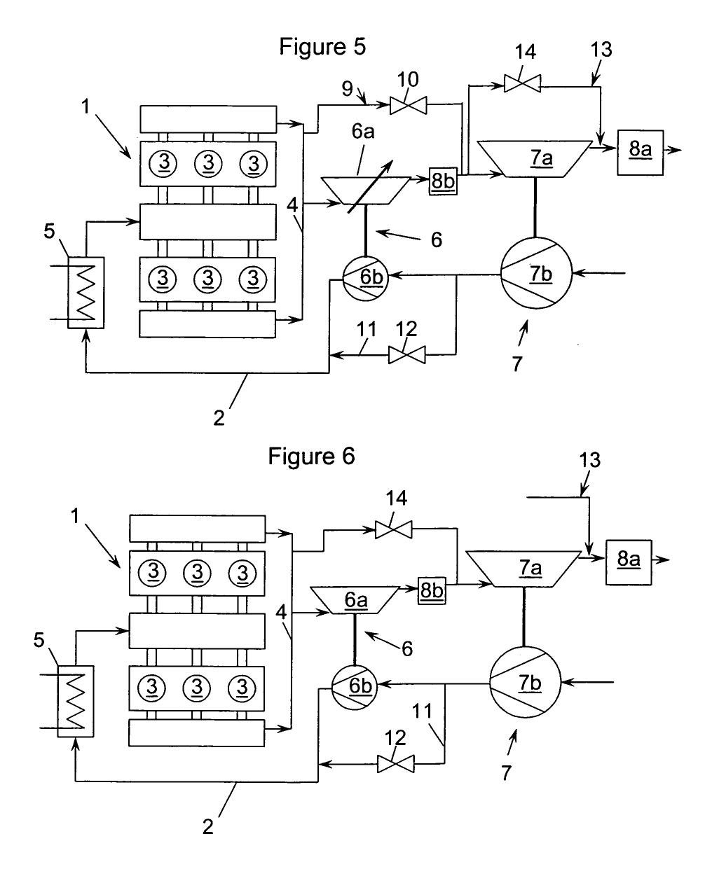

FIG. 5 schematically shows a fifth embodiment of the pressure-charged internal combustion engine 1. A first bypass line 9 is additionally provided in the internal combustion engine 1, this first bypass line 9 branching off from the exhaust-gas line 4 upstream of the turbine 6a of the first exhaust-gas turbocharger 6 and opening into the exhaust-gas line 4 again downstream of the second exhaust-gas aftertreatment system 8b, a valve 10 being arranged in this first bypass line 9.

FIG. 6 schematically shows a sixth embodiment of the pressure-charged internal combustion engine 1. In contrast to the embodiment shown in FIG. 2, a second bypass line 11 is provided in the internal combustion engine 1. This second bypass line 11 branching off from the intake line 2 upstream of the compressor 6b of the first exhaust-gas turbocharger 6 and opening into the intake line 2 again downstream of the compressor 6b of the first exhaust-gas turbocharger 6, a valve 12 being arranged in the second bypass line 11.

The second bypass line 11 allows the high-pressure compressor 6b to be bypassed. This enables the fresh-air mass flow passed through the high-pressure compressor 6b to be matched to the exhaust-gas mass flow passed through the high-pressure turbine 6a and thus permits adaptation to the turbine output instantaneously available.

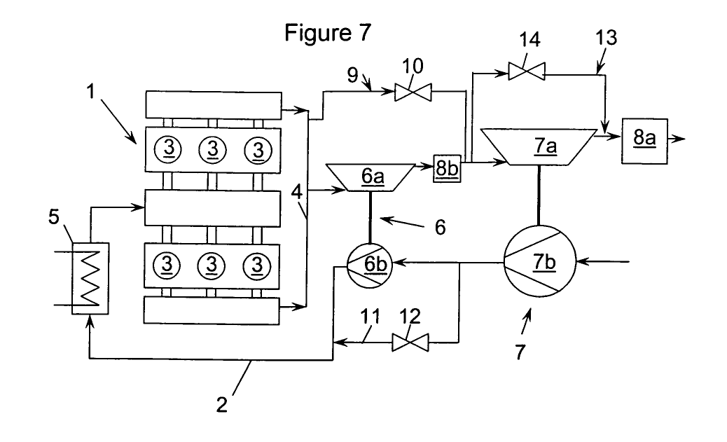

FIG. 7 schematically shows a seventh embodiment of the pressure-charged internal combustion engine 1. In contrast to the embodiment shown in FIG. 6, a third bypass line 13 is provided for the purposes of exhaust-gas bleeding, this third bypass line 13 branching off from the exhaust-gas line 4 upstream of the turbine 7a of the second exhaust-gas turbocharger 7 and opening into the exhaust-gas line 4 again upstream of the first exhaust-gas aftertreatment system 8a, it being possible for the turbine 7a of the second exhaust-gas turbocharger 7 to be bypassed by this second bypass line 13, a valve 14 being provided in the third bypass line 13 for controlling the exhaust-gas bleeding.

We claim:

1. A pressure-charged internal combustion engine (1), comprising:
an intake line (2) for supplying fresh air;
an exhaust-gas line (4) for discharging the exhaust gas;
a first exhaust-gas turbocharger (6) having a first turbine (6a) arranged in the exhaust-gas line (4) and a first compressor (6b) arranged in the intake line (2), said first exhaust-gas turbocharger (6) serving as a high-pressure stage;
a second exhaust-gas turbocharger (7) having a second turbine (7a) arranged in the exhaust-gas line (4) downstream of said first turbine (6a) and a second compressor (7b) arranged in the intake line (2) upstream of said first compressor (6b), said second exhaust-gas turbocharger (7) serving as a low-pressure stage;
a first exhaust-gas aftertreatment system (8a) arranged downstream of said second turbine (7a); and
a second exhaust-gas aftertreatment system (8b) arranged between said two turbines (6a, 7a).

2. The engine of claim 1, further comprising:
a bypass line (9) connecting said exhaust-gas line (4) upstream of said first turbine (6a) to said exhaust-gas line (4) downstream of said second exhaust-gas aftertreatment system (8b); and
a valve (10) arranged in said bypass line (9).

3. The engine of claim 1 wherein said valve (10) is a butterfly valve.

4. The engine of claim 1 wherein said first and second exhaust-gas aftertreatment systems (8a, 8b) are of a similar type.

5. The engine (1) of claim 1 wherein said second exhaust-gas aftertreatment system (8b) is volumetrically smaller than said first exhaust-gas aftertreatment system (8a).

6. The engine (1) of claim 1 wherein said first and second exhaust-gas aftertreatment systems (8a, 8b) are oxidation catalytic converters.

7. The engine (1) of claim 1 wherein said first and second exhaust-gas aftertreatment systems (8a, 8b) are diesel particulate filters.

8. The engine (1) of claim 1 wherein said first and second exhaust-gas aftertreatment systems (8a, 8b) are 3-way catalytic converters.

9. The engine (1) of claim 1, further comprising:
a bypass line (11) connecting said intake line (2) upstream of said second compressor (6b) to said intake line (2) downstream of said second compressor (6b); and
a valve (12) arranged in said bypass line (11).

10. The engine (1) of claim 1, further comprising: a charge-air cooler (5) arranged in said intake line (2) downstream of said first and second compressors (6b, 7b).

11. The engine (1) of claim 1 wherein said first turbine (6a) has a variable turbine geometry.

12. The engine (1) of claim 1 wherein said first compressor (6b) has a variable compressor geometry.

13. The engine (1) of claim 1 wherein said second turbine (7a) has a variable turbine geometry.

14. The engine (1) of claim 1, further comprising:
a bypass line (13) connecting said exhaust-gas line (4) upstream of said second turbine (7a) to said exhaust-gas line (4) downstream of said second turbine (7a); and
a valve (14) arranged in said bypass line (13).

15. A method for operating a pressure-charged internal combustion engine (1), comprising:
directing a predominant proportion of an exhaust gas-flow through a first turbine (6a) and a second exhaust-gas aftertreatment system (8b) during particular engine operating conditions wherein the engine (1) has an intake line (2) for supplying fresh air; an exhaust-gas line (4) for discharging the exhaust gas; a first exhaust-gas turbocharger (6) having said first turbine (6a) arranged in the exhaust-gas line (4) and a first compressor (6b) arranged in the intake line (2), said first exhaust-gas turbocharger (6) serving as a high-pressure stage; a second exhaust-gas turbocharger (7) having a second turbine (7a) arranged in the exhaust-gas line (4) downstream of said first turbine (6a) and a second compressor (7b) arranged in the intake line (2) upstream of said first compressor (6b), said second exhaust-gas turbocharger (7) serving as a low-pressure stage; a first exhaust-gas aftertreatment system (8a) arranged downstream of said second turbine (7a); and said second exhaust-gas aftertreatment system (8b) arranged between said two turbines (6a, 7a). The method of claim 15 wherein said particular operating conditions include: low exhaust mass flow and engine warm-up, said low exhaust mass flow occurring at low speed conditions and at low torque conditions.

17. The method of claim 15 wherein substantially all of said exhaust-gas flow is directed through said first turbine (6a) and said second exhaust-gas aftertreatment system (8b).

18. The method of claim 15, further comprising: increasing a proportion of exhaust-gas flowing through a bypass line (9) when one of exhaust temperature, exhaust pressure, and engine torque increase wherein said bypass line (9) connects said exhaust-gas line (4) upstream of said first turbine (6a) to said exhaust-gas line (4) downstream of said second exhaust-gas aftertreatment system (8b) and said bypass line (9) has a valve (10) arranged therein.

19. The method of claim 15 wherein more than 80% of exhaust-gas is directed through said first bypass line (9) when a temperature in said first exhaust gas-aftertreatment system (8a) is greater than a light-off temperature of said first exhaust gas-aftertreatment system (8a).

20. The method of claim 15, further comprising: adjusting a first valve (12) arranged in a first bypass line (11) based on a position of a second valve (10) arranged in a second bypass line wherein said first bypass line (11) connects said intake line (2) upstream of said first compressor (6b) to said intake line (2) downstream of said first compressor (6b), said second bypass line (9) connects said exhaust-gas line (4) upstream of said first turbine (6a) to said exhaust-gas line (4) downstream of said second exhaust-gas aftertreatment system (8b).

21. The method of claim 15, further comprising: increasing exhaust-gas flow bypassing said second turbine (7a) when at least one of an engine torque and an engine speed increase wherein said exhaust-gas flow is conducted through a bypass line (13) connecting said exhaust-gas line (4) upstream of said second turbine (7a) to said exhaust-gas line (4) downstream of said second turbine (7a) said bypass line (13) having a valve (14) arranged therein.
